(19) United States
(12) Patent Application Publication
(10) Pub. No.: US 2014/0059107 A1
(43) Pub. Date: Feb. 27, 2014

(54) SHARING APPARATUS FOR COMPUTER PERIPHERAL DEVICE

(71) Applicant: Ming-Tse YANG, Taipei City (TW)

(72) Inventor: Ming-Tse YANG, Taipei City (TW)

(21) Appl. No.: 13/592,779

(22) Filed: Aug. 23, 2012

(51) Int. Cl. G06F 15/16

(52) U.S. Cl. 709/201

(57) ABSTRACT

A sharing apparatus for computer peripheral devices includes: a source end connected to a first computer for sending via a first wireless module data of peripheral devices connected to the first computer; at least a target end having an identification code and connected to a second computer, wherein the target end receives and sends the data of the peripheral devices to the second computer, and the second computer performs an operation according to the data of the peripheral devices; and a control program stored in a record medium and installed in the first computer, wherein the source end fetches an identification code from the at least a target end via wireless connection, authenticates the identification code, adds a code corresponding to the identification code to the outgoing data of the peripheral device, and sends the code-containing data to a corresponding one of the target ends.

### BACKGROUND OF THE INVENTION

1. Technical Field

The present invention relates to data switchers, and more particularly, to a sharing apparatus for computer peripheral devices.

2. Description of Related Art

Taiwan Patent M432869 discloses a computer switcher that comprises a computer end control module, an IP sharing module, and a network transmission module and thus can be connected to a remote computer apparatus by wireless connection or 3G connection, so as to enable a remote system administrator to control at least a local computer apparatus and perform data transmission therewith.

Although the aforesaid prior art discloses performing data exchange by means of wireless connection, it requires a complicated technical solution and incurs high component costs, because it entails connecting remote and local computers and performing data transmission therebetween with an IP sharing module. Moreover, the aforesaid prior art not only requires configuring an IP address and related network transmission settings but also renders an installation process intricate.

In addition, the aforesaid prior art discloses switching between a keyboard, a mouse, and a screen but does not provide diverse sharing functions for computer peripheral devices; as a result, the benefits and functions provided by the aforesaid prior art are still restricted to conventional application.

### SUMMARY OF THE INVENTION

It is an objective of the present invention to provide a sharing apparatus for computer peripheral devices and thereby enable the computer peripheral devices to be capable of plug-and-play (PnP) without configuring an IP address and configuring network transmission-related parameters, thus simplifying the required hardware, cutting costs, and rendering an installation process easy.

Another objective of the present invention is to provide a sharing apparatus for computer peripheral devices which are more diverse than are permitted by the prior art.

In order to achieve the above and other objectives, the present invention provides a sharing apparatus for computer peripheral devices. The sharing apparatus comprises: a source end having a first wireless module, a first external interface, a first microcomputer, and a memory, the first external interface being connected to a first computer, and the first microcomputer receiving data attributed to the peripheral devices and transmitted from the first computer via the first external interface and sending the data via the first wireless module; at least a target end having a second wireless module, a second external interface, a second microcomputer, and an identification code, the second wireless module being electrically connected to the first wireless module by wireless connection, the second external interface being connected to a second computer, the second microcomputer receiving the data from the peripheral devices through a connection between the second wireless module and the first wireless module and sending the data to the second computer via the second external interface so as for the second computer to perform an operation according to the data, and the identification code being stored in a hardware and thereby disposed at a corresponding one of the at least a target end in a manner that the identification codes vary from target end to target end; and a control program stored in a record medium and thereby installed in the first computer for not only instructing, when executed, the first computer to send the data from the peripheral devices connected to the first microcomputer via the first external interface but also enabling a user to select the at least a target end, wherein the source end fetches an identification code from the at least a target end via wireless connection, authenticates the identification code, adds a code corresponding to the identification code to the outgoing data of the peripheral device, and sends the code-containing data to a corresponding one of the target ends. Accordingly, the above and other objectives of the present invention can be achieved.

Preferably, the peripheral device is a keyboard, a mouse, a joystick, a gamepad, a screen, an audio source device, a remote controller, or a combination thereof.

Preferably, the first wireless module and the second wireless module apply radio frequency (RF) technology or Wi-Fi technology.

Preferably, the memory is integrated in the first microcomputer.

Preferably, the first external interface and the second external interface are USB interfaces.

Preferably, the record medium is a compact disc, a USB flash drive, or a memory.

Preferably, the record medium further stores an automatic execution program which is automatically executed as soon as the first external interface is connected to the first computer, and the execution of the automatic execution program entails examining the first computer to determine whether a virtual disk thereof has been created, such that, if the determination is negative, a virtual disk will be created to operate on the first computer, and the automatic execution program will install the control program in the virtual disk and execute the control program.

Preferably, the hardware storing the identification code is the second microcomputer or another memory.

### BRIEF DESCRIPTION OF THE DRAWINGS

Objectives, features, and advantages of the present invention are hereunder illustrated with preferred embodiments in conjunction with the accompanying drawings, in which:

FIG. 1 is a block diagram of the first preferred embodiment of the present invention; and

FIG. 2 is a block diagram of the second preferred embodiment of the present invention.

### DETAILED DESCRIPTION OF THE EMBODIMENTS OF THE INVENTION

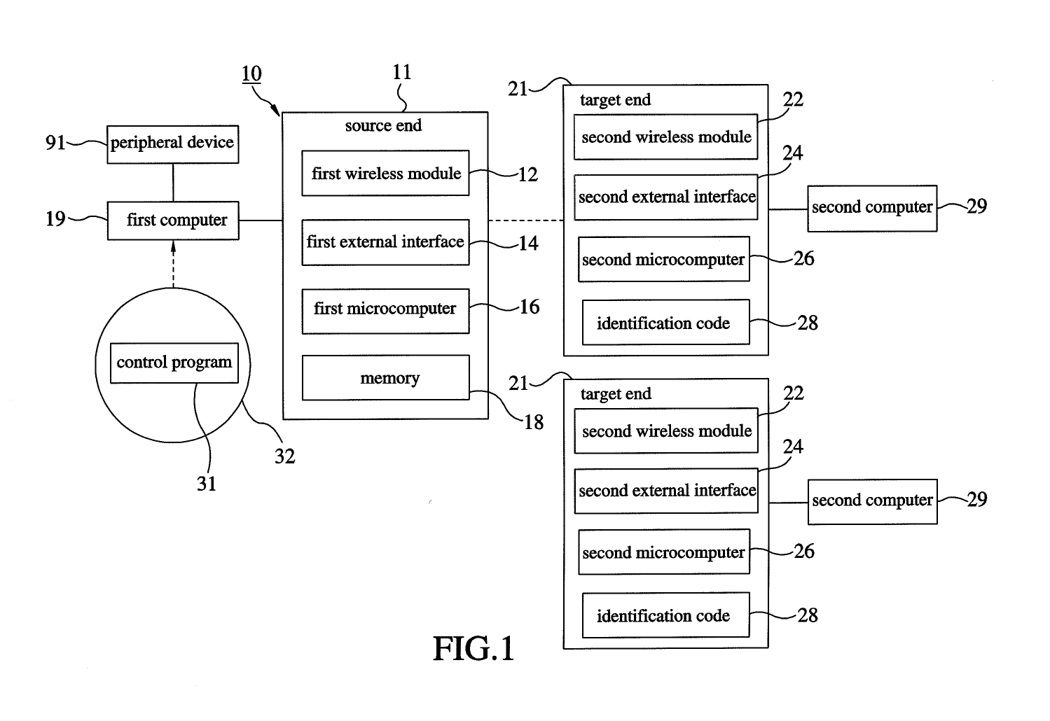

Referring to FIG. 1, there is shown a block diagram of a sharing apparatus 10 for computer peripheral devices according to the first preferred embodiment of the present invention. The sharing apparatus 10 essentially comprises a source end 11, at least a target end 21, and a control program 31.

The source end 11 has a first wireless module 12, a first external interface 14, a first microcomputer 16, and a memory 18. The first external interface 14 is connected to a first computer 19. The first microcomputer 16 receives data via the first external interface 14 which is sent from the first computer 19 and attributed by a peripheral device 91, and then sends the data of the peripheral device 91 via the first wireless module 12. In this embodiment, the peripheral device 91 is a keyboard, a mouse, a joystick, a gamepad (such as a steering wheel, a joystick, or a gamepad), a screen, an audio source device (such as a sound card or an CD-ROM drive), a remote controller, or a combination thereof. In practice, the memory 18 either operates independently of the first microcomputer 16 or is integrated in the first microcomputer 16.

The quantity of the at least a target end 21 is one or multiple. This embodiment is exemplified by two target ends 21. The target ends 21 each have a second wireless module 22, a second external interface 24, a second microcomputer 26, and an identification code 28. The second wireless module 22 is electrically connected to the first wireless module 12 by wireless connection. In this embodiment, the first wireless module 12 and the second wireless module 22 apply radio frequency (RF) technology or Wi-Fi technology, and is exemplified by a Wi-Fi module. The second external interface 24 is connected to a second computer 29. The second microcomputer 26 receives data from the peripheral device 91 by means of a connection between the second wireless module 22 and the first wireless module 12, and sends the data of the peripheral device 91 to the second computer 29 via the second external interface 24. Then, the second computer 29 performs an operation according to the data of the peripheral device 91. The identification code 28 is stored in a hardware and thereby disposed at a corresponding one of the target ends 21. The hardware that stores the identification code 28 is the second microcomputer 26 or another memory (not shown). In practice, since the identification code 28 comes in the form of numerical data, the identification code 28 can be directly stored in a memory which is of limited capacity and is built in the second microcomputer 26 or can be stored in a memory (not shown) and then electrically connected to the second microcomputer 26. However, the ways of storing the identification code 28 are disclosed in the prior art and thus are not described herein for the sake of brevity.

The control program 31 is stored in a record medium 32 and thereby installed in the first computer 19. When executed, the control program 31 not only instructs the first computer 19 to send data from the peripheral device 91 connected thereto to the first microcomputer 16 via the first external interface 14 but also enables a user to select a corresponding one of the target ends 21. In this embodiment, the record medium 32 is a compact disc, a USB flash drive, or the memory 18. If the record medium 32 is the memory 18, the control program 31 will be stored in the source end 11. If the record medium 32 is a compact disc, the user will have to insert the compact disc into the first computer 19 and then install the control program 31.

The source end 11 fetches the identification code 28 from the target ends 21 via wireless connection and authenticates the identification code 28. Afterward, a code corresponding to the identification code 28 is added to the outgoing data of the peripheral device 91, and then the code-containing data are sent to a corresponding one of the target ends 21.

In this embodiment, the first external interface 14 and the second external interface 24 are exemplified by USB interfaces. However, in addition to USB interfaces, the embodiment of the first external interface 14 and the second external interface 24 includes any other interfaces (such as RS-232 serial interfaces or printing ports) connectable to a computer.

The framework of the first embodiment is described above. The operation of the first embodiment is described below.

Referring to FIG. 1, before starting an operation, the user connects the source end 11 to the first computer 19 and connects the two target ends 21 to two second computers 29, respectively. Then, the user connects the record medium 32 to the first computer 19, executes the control program 31, and selects one of the target ends 21 (or both the two target ends 21, though this embodiment is exemplified by the selection of one of the target ends 21.) At this point in time, a wireless connection between the source end 11 and the two target ends 21 is created by means of the first wireless module 12 and the second wireless modules 22.

To start an operation, the user enters data into the peripheral device 91 (for example, typing a text with a keyboard) connected to the first computer 19, and then the control program 31 instructs the first computer 19 to send the data to the first microcomputer 16. After receiving the data, the first microcomputer 16 incorporates into the data a code corresponding to the identification code 28 at the selected one of the target ends 21 and then sends the code-containing data. The selected one of the target ends 21 receives the code-containing data from the source end 11 by wireless connection, and then performs a comparison process to determine whether the code matches the identification code 28 of the selected target end 21 itself. If the determination is affirmative, the selected target end 21 will confirm receipt of the data and send the data to the second computer 29 via the second external interface 24, such that the second computer 29 performs an operation according to the data. In the aforesaid example, with the received data being the text typed with a keyboard, the second computer 29 treats the text as one typed with a keyboard of the second computer 29 and performs an operation accordingly.

To terminate an operation, the user disconnects the source end 11 and the target ends 21 from the first computer 19 and the second computer 29.

The peripheral device 91 is exemplified by a keyboard. However, if the peripheral device 91 is a mouse, an audio source device, or any other device, data generated by the peripheral device 91 will always be sent from the first computer 19 to the second computer 29 in the aforesaid manner to cause the second computer 29 to perform a corresponding operation.

Hence, in the first embodiment, it is feasible to enable the computer peripheral devices to be capable of plug-and-play (PnP) without configuring an IP address and network transmission-related parameters, thus simplifying the required hardware, cutting costs, and rendering an installation process easy.

Furthermore, in the first embodiment, the sharing computer peripheral devices are more diverse than are permitted by the prior art.

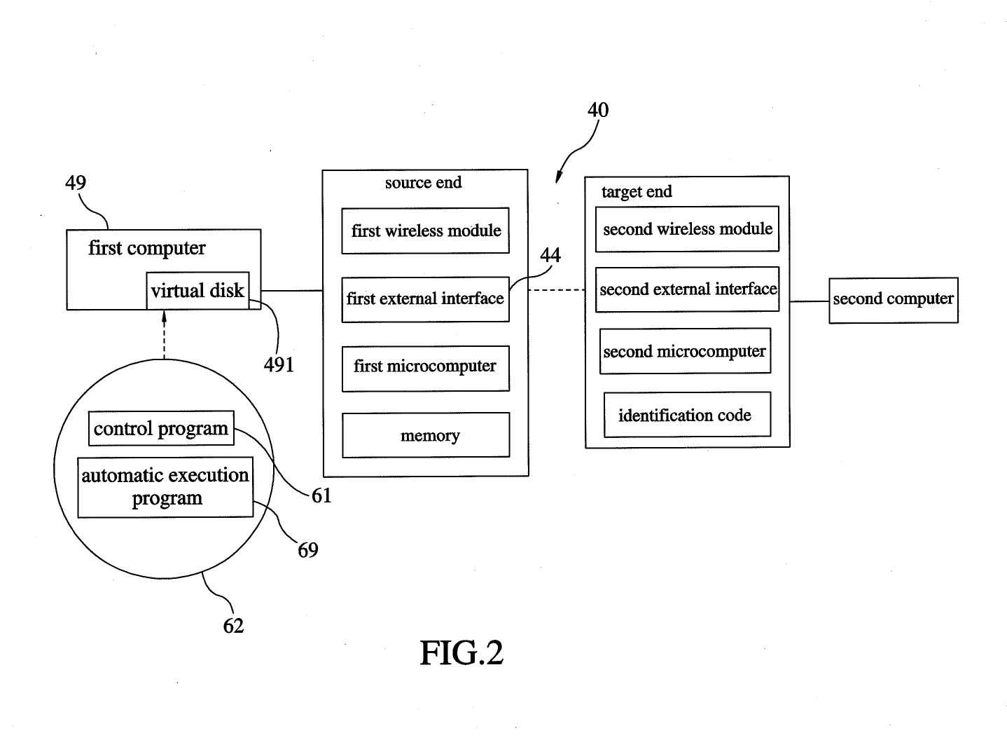

Referring to FIG. 2, a sharing apparatus 40 for computer peripheral devices in the second embodiment of the present invention is similar to that in the first embodiment of the present invention, except the following:

The record medium 62 further stores an automatic execution program 69. The automatic execution program 69 is automatically executed as soon as the first external interface 44 is connected to a first computer 49. The execution of the automatic execution program 69 entails examining the first computer 49 to determine whether a virtual disk thereof has been created. If the determination is negative, a virtual disk 491 will be created to operate on the first computer 49. Afterward, the automatic execution program 69 installs the control program 61 in the virtual disk 491 and executes the control program 61.

Accordingly, once the user connects the record medium 62 to the first computer 49, the first computer 49 will automatically install and execute the control program 61, thereby dispensing with the user's operation and enhancing ease of use.

Remaining structures and functions achievable by the remaining structures of the second embodiment are identical to that of the first embodiment and thus are not described herein for the sake of brevity.

What is claimed is:

1. A sharing apparatus for computer peripheral devices, the sharing apparatus comprising:
a source end having a first wireless module, a first external interface, a first microcomputer, and a memory, the first external interface being connected to a first computer, and the first microcomputer receiving data attributed by the peripheral devices and transmitted from the first computer via the first external interface and sending the data via the first wireless module;
at least a target end having a second wireless module, a second external interface, a second microcomputer, and an identification code, the second wireless module being electrically connected to the first wireless module by wireless connection, the second external interface being connected to a second computer, the second microcomputer receiving the data from the peripheral devices through a connection between the second wireless module and the first wireless module and sending the data to the second computer via the second external interface so as for the second computer to perform an operation according to the data, and the identification code being stored in a hardware and thereby disposed at a corresponding one of the at least a target end in a manner that the identification codes vary from target end to target end; and
a control program stored in a record medium and thereby installed in the first computer for not only instructing, when executed, the first computer to send the data from the peripheral devices connected to the first microcomputer via the first external interface but also enabling a user to select the at least a target end,
wherein the source end fetches an identification code from the at least a target end via wireless connection, authenticates the identification code, adds a code corresponding to the identification code to the outgoing data of the peripheral device, and sends the code-containing data to a corresponding one of the target ends.

2. The sharing apparatus of claim 1, wherein the peripheral device is one of a keyboard, a mouse, a joystick, a gamepad, a screen, an audio source device, a remote controller, and a combination thereof.

3. The sharing apparatus of claim 1, wherein the first wireless module and the second wireless module apply one of radio frequency (RF) technology and Wi-Fi technology.

4. The sharing apparatus of claim 1, wherein the memory is integrated in the first microcomputer.

5. The sharing apparatus of claim 1, wherein the first external interface and the second external interface are USB interfaces.

6. The sharing apparatus of claim 1, wherein the record medium is one of a compact disc, a USB flash drive, and a memory.

7. The sharing apparatus of claim 1, wherein the record medium further stores an automatic execution program which is automatically executed as soon as the first external interface is connected to the first computer, and the execution of the automatic execution program entails examining the first computer to determine whether a virtual disk thereof has been created, such that, if the determination is negative, a virtual disk will be created to operate on the first computer, and the automatic execution program will install the control program in the virtual disk and execute the control program.

8. The sharing apparatus of claim 1, wherein the hardware storing the identification code is the second microcomputer or another memory.
